(19) United States
(12) Patent Application Publication
(10) Pub. No.: US 2003/0218976 A1
(43) Pub. Date: Nov. 27, 2003

(54) Packet-transmitting apparatus and method

(76) Inventors: Masayuki Kumazawa, Yokohama (JP); Mikio Shimazu, Kasuya-Gun (JP); Yuji Shimizu, Koga (JP)

Correspondence Address: WENDEROTH, LIND & PONACK, L.L.P., 2033 K STREET N. W., SUITE 800, WASHINGTON, DC, 20006-1021, US

(21) Appl. No.: 10/404,098

(22) Filed: Apr. 2, 2003

(30) Foreign Application Priority Data
Apr. 5, 2002 (JP) 2002-103774

(51) Int. Cl. H04L 1/00

(52) U.S. Cl. 370/229; 370/392

(57) ABSTRACT

A packet-transmitting apparatus operable to receive incoming packets and to feed non-discarded packets sequentially to the outside, comprising: a flow-classifying unit operable to classify the incoming packets for each flow; a flow-determining unit operable to determine whether each of the flows falls within a range of an available band that is defined by an upper limit band of each of the flows; and an upper limit band-renewing unit operable to renew the upper limit band with reference to a determination result from the flow-determining unit, wherein there are cases where the upper limit band-renewing unit renews the upper limit band in such a manner that the upper limit band exceeds a value obtained from a line capacity divided by the number of the flows.

### BACKGROUND OF THE INVENTION

1. Field of the Invention

The present invention relates to a packet-transmitting apparatus designed to transmit packets in a packet-switching network while enabling control over each flow band, and an art related thereto.

2. Description of the Related Art

A packet-transmitting apparatus as previously mentioned is realized by various embodiments such as a rooter, a switch, or a board having main functions thereof. Such a packet-transmitting apparatus employs the most universal WFQ (Weighted Fair Queuing) as a scheduling method for effecting fair band control for each flow. The WFQ provides queues that are equal in number to the flows. In order to provide an equalized band available for each of the flows, the WFQ controls the sequence in which transmission-queued packets residing for each of the queues is transmitted. As a result, a fair band guarantee is provided.

In a typical packet-transmitting net, or rather the Internet, there can be plural places where congestion occurs. In order to provide complete band control end to end using the WFQ, the WFQ must be implemented at all of the places where the congestion may occur. However, such implementation is virtually impossible in practice.

U.S. Pat. Nos. 5,802,106, 6018516, and 6038216, which is an art of executing band control at a single location using characteristics of flows according to TCP (Transmission Control Protocol), regardless of whether or not the congestion occurs. The TCP flow represents nearly entire portion of traffic that flows over the Internet.

According to the TCP, when there are data-sending and data-receiving terminals, the data-receiving terminal sends back an ACK packet to the data-sending terminal as receipt confirmation upon receipt of packets therefrom. According to the above-mentioned U.S. Patents, a “window size”, i.e., a header field of the ACK packet is rewritten to control a data-sending speed at the data-sending terminal by packet-transmitting apparatus except the data-receiving terminal.

However, the prior art has a problem of increased processing loads because of the following: the ACK packet from the data-receiving terminal to the data-sending terminal as well as data packet from the data-sending terminal to the data-receiving terminal must be controlled; the packet header field must be rewritten; and, a check sum in a packet header must be rewritten because of the header field rewriting.

In addition, the above-mentioned [TCP 1999] (Shrinkrishna Karandikar, Shivkumar Kalyanaraman, Prasad Bagal, Bob Packer, “TCP Rate Control”, 1999; http://citeseer.nj.nec.com/304953.html) is inapplicable when a data rewriting-proof protocol such as IPSec is employed. Such as RTP and RTCP, when the sending rate is controlled in a higher layer than a transport layer, flow control is impossible, since the protocol of the transport layer is not TCP but UDP.

### OBJECTS AND SUMMARY OF THE INVENTION

In view of the above, an object of the present invention is to provide a packet-transmitting apparatus having a flow band control function, designed to work at high speeds in a simple manner, and to meet rate-controlled protocols other than TCP.

A first aspect of the present invention provides a packet-transmitting apparatus operable to receive incoming packets and to feed non-discarded packets sequentially to the outside, comprising: a flow-classifying unit operable to classify the incoming packets for each flow; a flow-determining unit operable to determine whether each of the flows falls within a range of an available band that is defined by an upper limit band of each of the flows; and an upper limit band-renewing unit operable to renew the upper limit band with reference to a determination result from the flow-determining unit, wherein there are cases where the upper limit band-renewing unit renews the upper limit band in such a manner that the upper limit band exceeds a value obtained from a line capacity divided by the number of the flows.

This construction monitors only packets moved from a sending terminal to a receiving terminal, and discards the packets if necessary, thereby controlling a corresponding flow band. This feature provides a packet-transmitting apparatus capable of controlling the flow band at high speeds.

A second aspect of the present invention provides a packet-transmitting apparatus operable to receive incoming packets and to feed non-discarded packets sequentially to the outside, comprising: a flow-classifying unit operable to classify the incoming packets for each flow; a flow-determining unit operable to determine whether each of the flows falls within a range of an available band that is defined by an upper limit band of each of the flows; an upper limit band-renewing unit operable to renew the upper limit band; and an overall band-determining unit operable to determine whether all of the flows lie within a range of an available band that is defined by an overall band value, wherein the upper limit band-renewing unit renews the upper limit band with reference to a determination result from the flow-determining unit and a determination result from the overall band-determining unit.

This construction provides reasonable band control in dependence upon a status, using a combination of the determination result from the flow-determining unit and that from the overall band-determining unit.

A third aspect of the present invention provides a packet-transmitting apparatus as defined in the second aspect of the present invention, wherein the upper limit band-renewing unit renews the upper limit band to provide an increased upper limit band when the determination result from the flow-determining unit is shown falling out of the range of the available band defined by the upper limit band, and when the determination result from the overall band-determining unit is shown falling within the range of the available band defined by the overall band value.

This construction allows the increased upper limit band to avoid suppressing a corresponding flow band.

A fourth aspect of the present invention provides a packet-transmitting apparatus as defined in the second aspect of the present invention, wherein the upper limit band-renewing unit renews the upper limit band to provide a reduced upper limit band when the determination result from the flow-determining unit is shown falling within the range of the available band defined by the upper limit band, and when the determination result from the overall band-determining unit is shown falling out of the range of the available band defined by the overall band value.

This construction allows the reduced upper limit band to restrain other flows that occupy a considerable area of the entire band, thereby guaranteeing fairness.

A fifth aspect of the present invention provides a packet-transmitting apparatus as defined in the second aspect of the present invention, wherein the incoming packets are discarded when the determination result from the flow-determining unit is shown falling out of the range of the available band defined by the upper limit band, and when the determination result from the overall band-determining unit is shown falling out of the range of the available band defined by the overall band value.

This construction discards the packets, thereby providing simple band control at high speeds.

A sixth aspect of the present invention provides a packet-transmitting apparatus as defined in the first aspect of the present invention, wherein the flow-classifying unit classifies the incoming packets in accordance with header information of each of the incoming packets.

This construction realizes concise flow classification according to the header information.

A seventh aspect of the present invention provides a packet-transmitting apparatus as defined in the first aspect of the present invention, wherein the upper limit band is common to all of the flows.

This construction realizes high-speed band control through simple processing.

An eighth aspect of the present invention provides a packet-transmitting apparatus as defined in the first aspect of the present invention, wherein the upper limit band is weighted for each of the flows.

The weighting provides band control in dependence upon importance of each of the flows.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram, illustrating an exemplary packet-transmitting apparatus according to an embodiment of the present invention;

FIG. 2(a) is an illustration, showing a structure of an exemplary flow table;

FIG. 2(b) is an illustration, showing a structure of an exemplary overall band table;

FIG. 2(c) is a descriptive illustration, showing exemplary processing according to a combination of a flow determination and an overall band determination;

FIG. 3 is a flow chart, illustrating how the packet-transmitting apparatus is operated;

FIG. 4 is a flow chart, showing how the flow determination is made;

FIG. 5 is a flow chart, illustrating how the overall band determination is made;

FIG. 6 is a flow chart, illustrating how an upper limit band is renewed;

FIG. 7 is a graph, illustrating exemplary throughput after band control is effected; and

FIG. 8 is a graph, illustrating throughput before the band control is executed.

### DETAILED DESCRIPTION OF THE PREFERRED EMBODIMENT

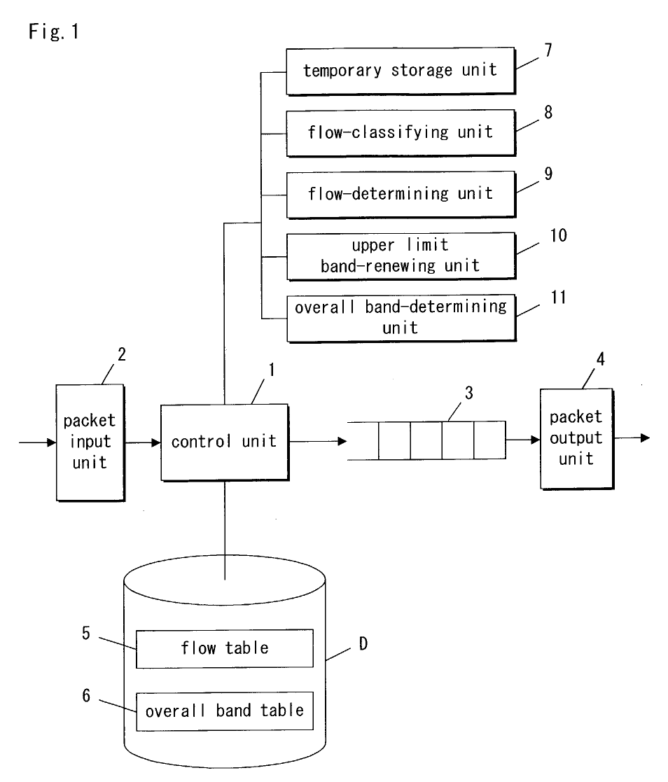

An embodiment of the present invention will now be described with reference to the drawings. FIG. 1 is a block diagram, illustrating an exemplary packet-transmitting apparatus according to the present embodiment.

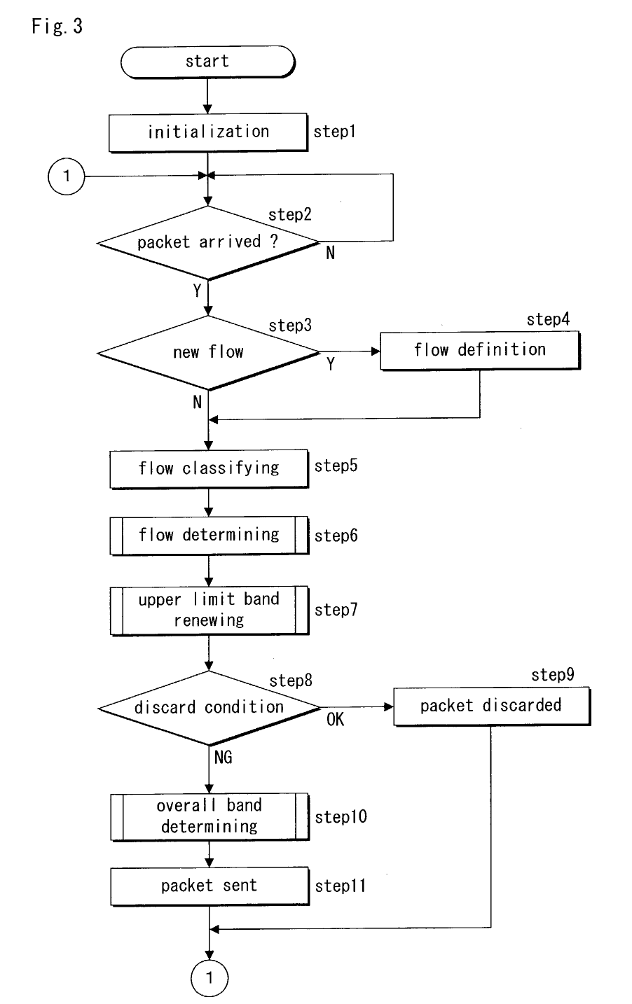

Referring to FIG. 1, a control unit 1 controls other components of FIG. 1 in accordance with a flowchart of FIG. 3.

A packet input unit 2 receives incoming packets. The incoming packets are to be processed as discussed later under the control of the control unit 1. The packets are set in a queue 3 unless being determined as being discarded. The packets in the queue 3 are sent out to a destination through a packet output unit 4 on a FIFO (First In First Out) basis.

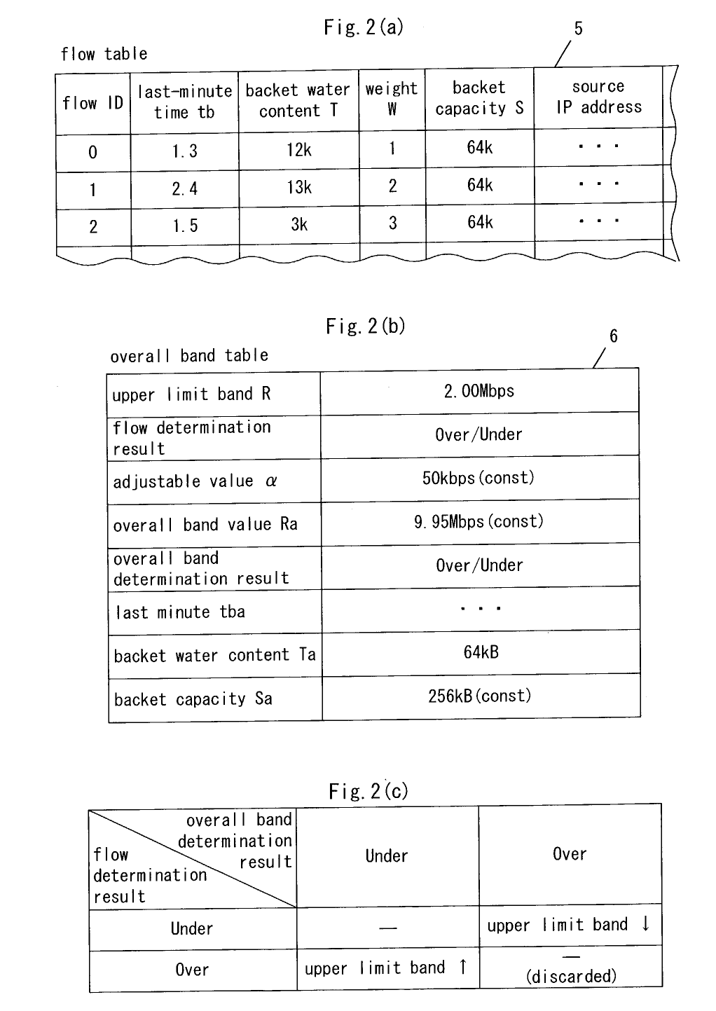

The control unit 1 references a temporary storage unit 7 and a recording apparatus “D”. The temporary storage unit 7 includes a memory, and tentatively stores information that is necessary for the control unit 1 to practice processing. The recording apparatus D includes a hard disc, or otherwise a memory. The recording apparatus D contains a flow table 5 as illustrated in FIG. 2(a) and an overall band table 6 as illustrated in FIG. 2(b).

The term “flow” as given herein is now described. The flow is a unit of a packet flow whose band is to be guaranteed by the packet-transmitting apparatus. According to the present embodiment, a flow of packets having the same source IP address, the same destination IP address, the same source port number, the same destination port number, and the same protocol is regarded as a certain flow. The information such as the destination IP address is obtainable with ease with reference to header information of a packet according to TCP/IP or otherwise header information of a packet according to UDP.

The flow according to the present invention is not limited to the above, but may alternatively be defined more broadly than the above. More specifically, attention may be directed more simply to the source IP address and the destination IP address. This means that a flow of packets having the same source IP address and the same destination IP address is considered as a certain flow. Conversely, the flow may be defined in a narrower manner as well. The present invention is applicable to these alternatives.

The packet input unit 2 as illustrated in FIG. 1 is not always connected to a single line. This means that the packets may arrive at the packet input unit 2 through plural lines. For convenience of description, assume that the packets arrive the packet input unit 2 through all lines that have a maximum line capacity of 10 Mbps. It goes without saying that the present invention is also applicable in case of a maximum line capacity greater than or less than 10 Mbps.

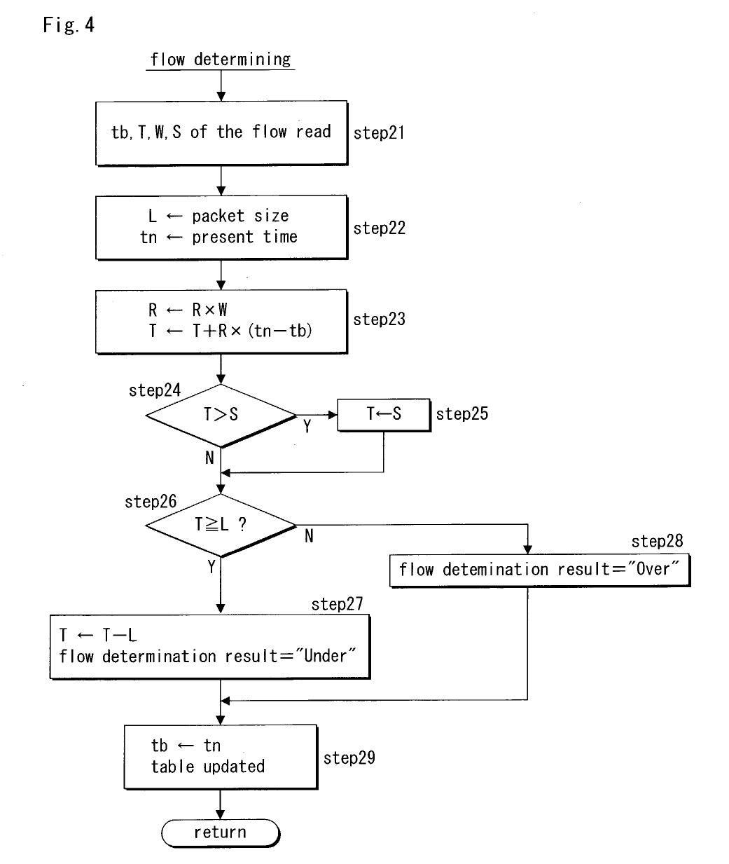

The flow table 5 is now discussed with reference to FIG. 2(a). Pursuant to the present embodiment, a flow-determining unit 9 makes a flow determination for each flow using a token bucket. Details of the flow determination are discussed later with reference to FIG. 4. The flow determination is to determine whether each of the flows falls within a range of an available band defined by an upper limit band of each of the flow.

The flow table 5 contains information necessary for the flow determination and flow-defining information such as the destination IP address as discussed above. More specifically, the flow table 5 includes respective fields of “flow ID”, “last-minute time tb”, “bucket water content T”, and “bucket capacity S”. “Flow ID” is a unique identification number allocated for each of the flows. “Last-minute time tb” is a time when information on the token bucket is renewed at the last minute in connection with a flow identified by each flow ID. “Bucket water content T” is a quantity of water held in the token bucket in connection with the flow. “Bucket capacity S” is equivalent to a maximum of bucket water content T. Bucket water content T is increased by an amount obtained from upper limit band R (see FIG. 2(b)) per unit time multiplied by weight W of the flow. When bucket water content T reaches the bucket capacity S, then water “overflows” the token bucket, thereby allowing bucket water content T to be kept falling within a range of bucket capacity S.

The bucket water content T refers to a size of each packet that is allowed to transmit at present in the flow. When size L (byte) of an incoming packet is equal or smaller than water content T (byte) (L□T), then the incoming packet can be transmitted. This means that the flow lies within a range of an available band defined by upper limit band R. This status is hereinafter represented by the term “Under”. Conversely, the flow falls out of the range of the available band when a problem arises upon the transmission of the incoming packets. This status is hereinafter represented by the term “Over”.

Although the multiplication using weight W may be omitted, or weight W may be the same value, the use of weight W varied from a flow to a flow according to the present embodiment provides a more important flow (e.g., packets such as telephone call that requires promptness) with a broad available band, but provides a less important flow with a narrow available band. This feature provides a sharp band guarantee, and advantageously meets communication requirements.

A flow-classifying unit 8 as illustrated in FIG. 1 classifies the incoming packets for each flow with reference to the flow table 5, and then delivers a corresponding flow ID to the control unit 1. When incoming packets do not belong to any one of the flows defined in the flow table 5, then the flow-classifying unit 8 defines a new flow by providing a new flow ID thereto. The flow-classifying unit 8 sets the fields of the new flow, as illustrated in FIG. 2(a). As a result, the new flow is registered in the flow table 5.

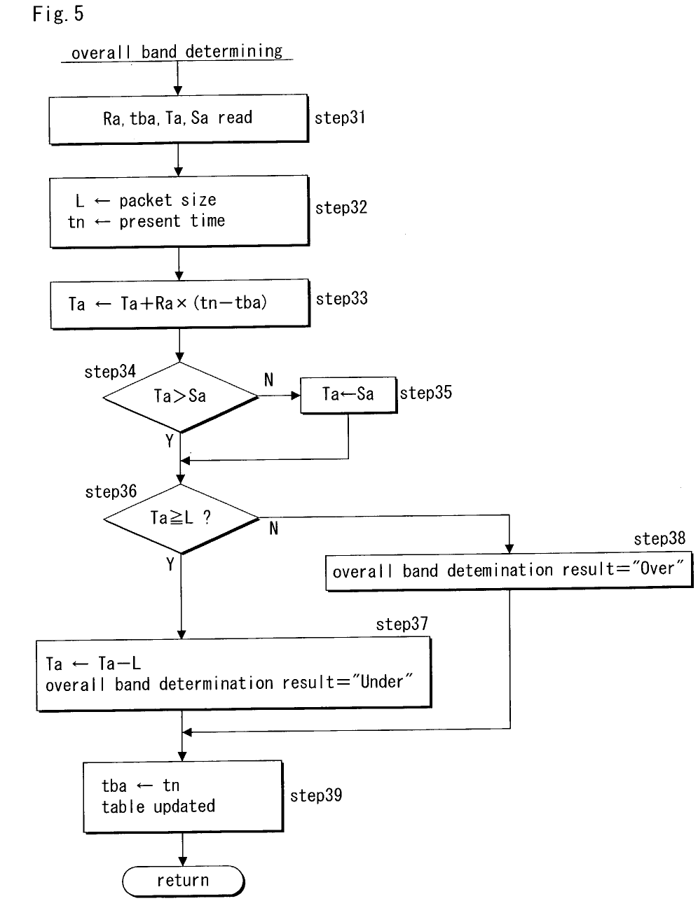

The overall band table 6 is now described with reference to FIG. 2(b). Pursuant to the present embodiment, an overall band-determining unit 11 makes an overall band determination of the entire band using the token bucket, as discussed later in detail with reference to FIG. 5. The overall band determination is to determine whether all flows lie within a range of an available band defined by overall band value Ra.

The overall band table 6 contains information necessary for the overall band determination. More specifically, the overall band table 6 includes respective fields of “overall band value Ra”, “overall band determination”, “bucket water content Ta”, and “bucket capacity Sa”. The filed of “overall band value Ra” holds a fixed value (9.95 Mbps according to the present embodiment) slightly smaller than the line capacity (10 Mbps according to the present embodiment). The field of “overall band determination” contains overall band determination results (Over/Under).

“Last-minute time tba” is a time at which previous overall band determination was made. Similarly to the foregoing, “bucket water content Ta” is a volume of water held in the token bucket for use in the overall band determination, while “bucket capacity Sa” is a maximum of “bucket water content Ta”.

The overall band determination result “Under” means that there are many bands unused in the line capacity. The overall band determination result “Over” refers to nearly full use of the line capacity.

Pursuant to the present embodiment, the overall band table 6 includes further fields, i.e., “upper limit band R”, “flow determination”, and “adjustment value”. Pursuant to the present embodiment, “upper limit band R” is common to all flows. “Upper limit band R” in combination with weight W is a rate at which water content in the token bucket for each flow is increased. The field of “flow determination” contains a flow determination result for a flow on which attention is focused. The field of “adjustment value” contains a value to adjust “upper limit band R”.

As seen from the above description, upper limit band R for use in the flow determination is a variable, and is varied according to a status, as discussed later in detail. Meanwhile, the token bucket rate (overall band value Ra) for use in the overall band determination is a constant.

Needless to say, respective values contained in the flow table 5 and those in the overall band table 6 are offered merely for purpose of illustration, and the present invention is not limited thereto. Furthermore, the flow table 5 and overall band table 6 are not limited in construction to the above, but may contain information in another manner.

Moreover, the overall band table 6 may contain plural sets of overall band value Ra and overall band determination results in order to monitor the entire band within finer limits.

The following discusses with reference to FIG. 2(c) the way in which the present embodiment provides processing using a combination of the flow determination results and the overall band determination results.

Case 1: Assume that the flow determination result and the overall band determination result are both “Under”.

This case shows that no congestion occurs in a flow related to the flow determination result. As a result, the upper limit band R remains unchanged.

Case 2: Assume that the flow determination result is “Over”, while the overall band determination result is “Under”.

In this case, incoming packets are often discarded according to the prior art because congestion occurs in a flow related to the above flow determination result.

The present case shows that upper limit band R suppresses a band of the flow although there are bands unused in the line capacity. Accordingly, upper limit band R is preferably greater than that the present value.

According to the present embodiment, the incoming packets are not discarded, but an adjustment value is added to upper limit band R to provide a greater upper limit band R.

Case 3: Assume that the flow determination result is “Under”, while the overall band determination result is “Over”.

Similarly, the prior art tends to discard the incoming packets because the overall band determination result is “Over”.

The present case shows that there is likelihood that the entire band is not fully used because a flow related to the above flow determination result is pressed by other flows. Accordingly, upper limit band value R is preferably smaller than that the present value in order to constrain other flows that occupy a considerable area of the entire band.

Pursuant to the present embodiment, the incoming packets are not discarded, but upper limit band value R is reduced by subtracting an adjustment value from upper limit band value R.

Case 4: Assume that the flow determination result and overall band determination result are both “Over”.

In this case, the incoming packets are discarded, while upper limit band value R remains unchanged.

The processing according to the above cases 1 to 4 allows upper limit band value R to always search for an appropriate value. According to the present embodiment, the same amount is added and subtracted from upper limit band value R. As an alternative, one value may be added to upper limit band value R, while another value is subtracted therefrom. As a result, the token bucket rate (upper limit band value R) for use in the flow determination is varied so as to become an appropriate value every second. This feature reduces the number of the discarded incoming packet to the utmost, and provides an enhanced efficiency of band availability.

The following discusses with reference to FIG. 4 the way in which the flow-determining unit 9 is operated. The flow-classifying unit 8 makes the above-described flow determination of a flow on which attention is focused.

At step 21, the flow-determining unit 9 reads out last-minute time tb, bucket water content T, weight W, and bucket capacity S from the flow table 5 in connection with the flow, while reading out upper limit band R from the overall band table 6.

At step 22, the flow-determining unit 9 determines incoming packet size L and present time tn.

At step 23, the flow-determining unit 9 calculates present bucket water content T (=T+R(tn−tb)) using value RW that is obtained from upper limit band R multiplied by weight W. T is equalized to S (T=S) at step 25 when T is greater than S (T>S) at step 24.

At step 26, the flow-determining unit 9 compares size L with bucket water content T. When T is equal or greater than L (T□L) at step 26, then the flow-determining unit 9 provides flow determination result “Under” at step 27. Bucket water content T is reduced by amount L. The routine is advanced to step 29. When T is smaller than L (T<L) at step 26, then the flow-determining unit 9 provides flow determination result “Over” at step 28. Bucket water content T remains unchanged. The routine is advanced to step 29.

At step 29, present time tn is set to last-minute time tb. At the same step 29, the overall band table 6 is renewed in content. As a result, the overall band table 6 has the field of “flow determination” set to either “Over” or “Under”.

The following discusses with reference to FIG. 5 the way in which the overall band-determining unit 11 is operated. The overall band-determining unit 11 practices the overall band determination as described above.

At step 31, the overall band-determining unit 11 reads out overall band value Ra, last-minute time tb, bucket water content Ta, and bucket capacity Sa from the overall band table 6. At step 32, the overall band-determining unit 11 determines incoming packet size L and present time tn.

At step 33, the overall band-determining unit 11 calculates present bucket water content Ta (=Ta+Ra (tn−tba)). Ta is equalized to Sa (Ta=Sa) at step 35 when Ta is greater than Sa (Ta>Sa) at step 34.

At step 36, the overall band-determining unit 11 compares size L with bucket water content Ta. When Ta is equal or greater than L (Ta□L) at step 36, then the overall band-determining unit 11 provides overall band determination result “Under” at step 37. Bucket water content Ta is reduced by amount L. The routine is advanced to step 39. When Ta is smaller than L (Ta<L) at step 36, then the overall band-determining unit 11 provides overall band determination result “Over” at step 38. Bucket water content Ta remains unchanged. The routine is advanced to step 39.

At step 39, present time tn is set to last-minute time tba. At the same step 39, the overall band table 6 is renewed in content. As a result, the overall band table 6 has the field of “overall band determination” set to either “Over” or “Under”.

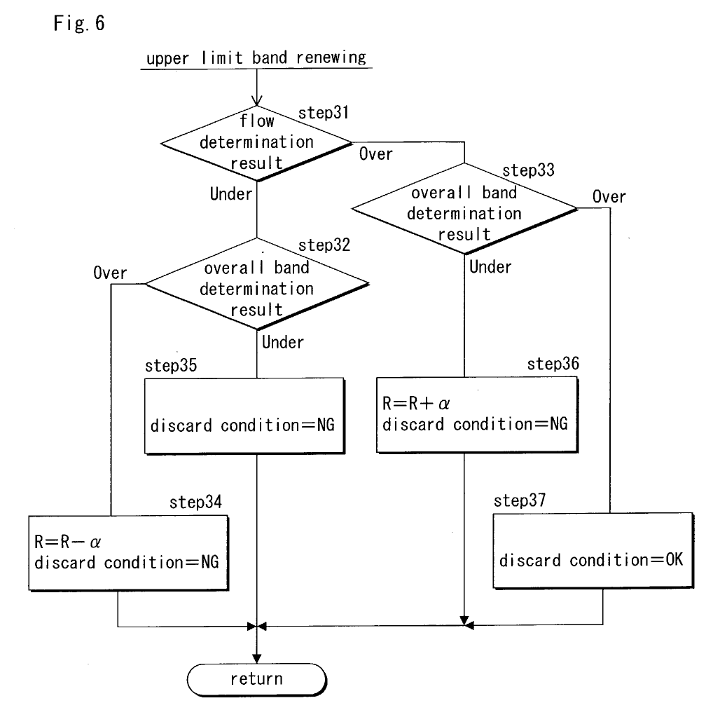

The following discusses with reference to FIG. 2(c) and FIG. 6 how an upper limit band-renewing unit 10 of FIG. 1 is run. A discard condition is a flag that show whether or not the incoming packets are discarded.

As illustrated in FIG. 6, the upper limit band-renewing unit 10 practices separate processing of the previously described cases 1 to 4. Referring to steps 31, 32 and 35 of FIG. 6, for case 1, the discard condition is unaccepted, while upper limit band R remains unchanged. Referring to steps 31, 33 and 36 of FIG. 6, for case 2, upper limit band R is increased by an amount of an adjustment value, while the discard condition is unaccepted.

Referring to steps 31, 32 and 34 of FIG. 6, for case 3, upper limit band R is reduced by an amount of the adjustment value, while the discard condition is unaccepted. Referring to steps 31, 33 and 37 of FIG. 6, for case 4, the discard condition is accepted, while upper limit band R remains unchanged.

In view of the above description, the overall operation of the packet-transmitting apparatus according to the present embodiment is now discussed with reference to FIG. 3.

At step 1, the control unit 1 initializes respective values of the flow table 5 and those of the overall band table 6. Upper limit band R may have any initialized value selected from within a range of zero Mbps to the full line capacity, i.e., 10 Mbps according to the present embodiment because upper limit band R is renewed to provide an appropriate value, as previously described.

At step 2, the control unit 1 waits for packets to arrive at the packet input unit 2. When the packets arrive thereat, then the control unit 1 passes them over to the flow-classifying unit 8.

The flow-classifying unit 8 checks each of the packets to determine whether it belongs to any one of the flows defined by the flow table 5. When it is determined that a packet belongs to a new flow that is undefined by the flow table 5, then the flow-classifying unit 8 places new flow-defining information into the flow table 5. At step 5, the flow-classifying unit 8 delivers a flow ID of the packet to the control unit 1.

At step 6, the control unit 1 permits the flow-determining unit 9 to make a flow determination, thereby providing a flow determination result. The flow determination result is set in the overall band table 6. At step 7, the control unit 1 permits the upper limit band-renewing unit 10 to practice the processing as illustrated in FIG. 6.

At step 8, the control unit 1 checks the discard condition related to the packet. When the discard condition is acceptable, then at step 9, the packet is discarded, not being sent out to the queue 3. The routine is returned to step 2.

When the discard condition is unacceptable at step 8, then at step 10, the control unit 1 permits the overall band-determining unit 11 to make an overall band determination, thereby providing an overall band determination result. As a result, the overall band determination result is set in the overall band table 6. The packet is moved to the queue 3. The moved packet is sent to a destination through the packet output unit 4. The control unit 1 returns the routine to step 2.

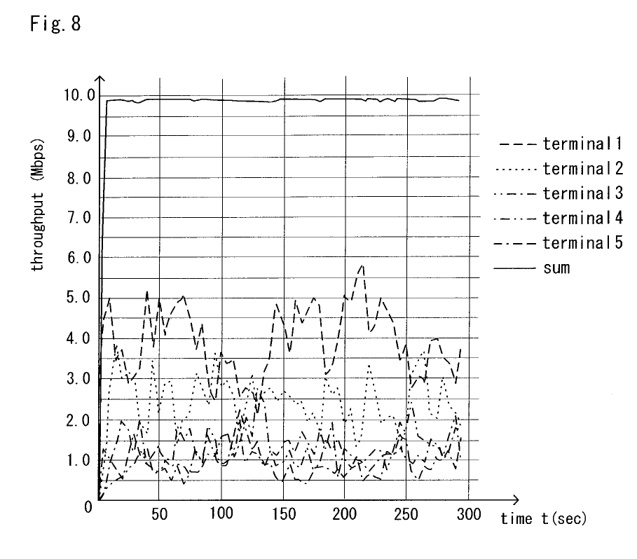

The following discusses an example in which the packet-transmitting apparatus according to the present embodiment is used. FIG. 8 illustrates variations on a time basis in throughput of five different terminals (Nos. 1 to 5) when each of the terminals transmits packets without constraints on a band. In this example, terminal No. 1 occupies a broad area of the band, with the result that terminals Nos. 4 and 5 are compelled to use very narrow areas of the band.

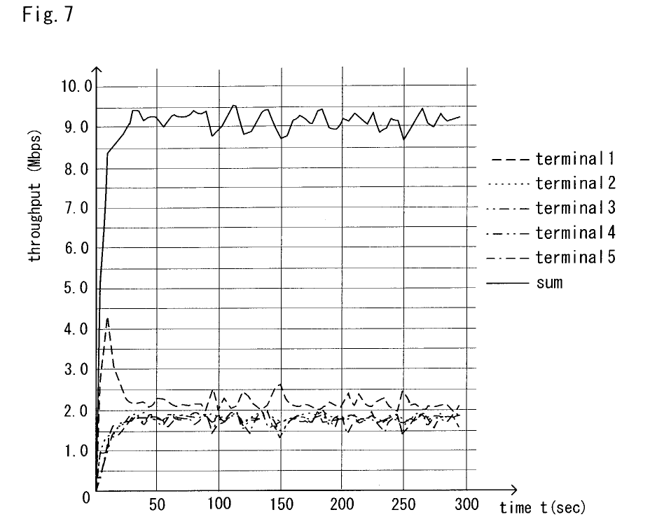

FIG. 7 illustrates results from the use of the packet-transmitting apparatus according to the present embodiment. It is understood from FIG. 7 that each of the terminals can fairly use the entire band. Another feature of the present embodiment is that overall throughput is negligibly reduced, when compared with that of FIG. 8.

Pursuant to the present invention, fair control over each flow band is achievable, and is also attainable in accordance with weight when the weight is set.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A packet-transmitting apparatus operable to receive incoming packets and to feed non-discarded packets sequentially to outside, comprising:
a flow-classifying unit operable to classify the incoming packets for each flow;
a flow-determining unit operable to determine whether each of the flows falls within a range of an available band that is defined by an upper limit band of each of the flows; and
an upper limit band-renewing unit operable to renew the upper limit band with reference to a determination result from said flow-determining unit,
wherein there are cases where said upper limit band-renewing unit renews the upper limit band in such a manner that the upper limit band exceeds a value obtained from a line capacity divided by number of the flows.

2. A packet-transmitting apparatus operable to receive incoming packets and to feed non-discarded packets sequentially to outside, comprising:
a flow-classifying unit operable to classify the incoming packets for each flow;
a flow-determining unit operable to determine whether each of the flows falls within a range of an available band that is defined by an upper limit band of each of the flows;
an upper limit band-renewing unit operable to renew the upper limit band; and
an overall band-determining unit operable to determine whether all of the flows lie within a range of an available band that is defined by an overall band value,
wherein said upper limit band-renewing unit renews the upper limit band with reference to a determination result from said flow-determining unit and a determination result from said overall band-determining unit.

3. A packet-transmitting apparatus as defined in claim 2, wherein said upper limit band-renewing unit renews the upper limit band to provide an increased upper limit band when the determination result from said flow-determining unit is shown falling out of the range of the available band defined by the upper limit band, and when the determination result from said overall band-determining unit is shown falling within the range of the available band defined by the overall band value.

4. A packet-transmitting apparatus as defined in claim 2, wherein said upper limit band-renewing unit renews the upper limit band to provide a reduced upper limit band when the determination result from said flow-determining unit is shown falling within the range of the available band defined by the upper limit band, and when the determination result from said overall band-determining unit is shown falling out of the range of the available band defined by the overall band value.

5. A packet-transmitting apparatus as defined in claim 2, wherein the incoming packets are discarded when the determination result from said flow-determining unit is shown falling out of the range of the available band defined by the upper limit band, and when the determination result from said overall band-determining unit is shown falling out of the range of the available band defined by the overall band value.

6. A packet-transmitting apparatus as defined in claim 1, wherein said flow-classifying unit classifies the incoming packets in accordance with header information of each of the incoming packets.

7. A packet-transmitting apparatus as defined in claim 1, wherein the upper limit band is common to all of the flows.

8. A packet-transmitting apparatus as defined in claim 1, wherein the upper limit band is weighted for each of the flows.

9. A packet-transmitting method comprising:
receiving incoming packets and feeding non-discarded packets sequentially to outside;
classifying the incoming packets for each flow;
determining whether each of the flows falls within a range of an available band that is defined by an upper limit band of each of the flows; and
renewing the upper limit band with reference to a result from the determination,
wherein there are cases where the upper limit band is renewed to exceed a value obtained from a line capacity divided by number of the flows.

10. A packet-transmitting method comprising:
receiving incoming packets and feeding non-discarded packets sequentially to outside;
classifying the incoming packets for each flow;
determining whether each of the flows falls within a range of an available band that is defined by an upper limit band of each of the flows; and
determining whether all of the flows lie within a range of an available band that is defined by an overall band value,
wherein the upper limit band is renewed with reference to a determination result for each of the flows and a determination result for all of the flows.

11. A packet-transmitting method as defined in claim 10, wherein the upper limit band is renewed to provide an increased upper limit band when the determination result for each of the flows is shown falling out of the range of the available band defined by the upper limit band, and when the determination result for all of the flows is shown falling within the range of the available band defined by the overall band value.

12. A packet-transmitting method as defined in claim 10, wherein the upper limit band is renewed to provide a reduced upper limit band when the determination result for each of the flows is shown falling within the range of the available band defined by the upper limit band, and when the determination result for all of the flows is shown falling out of the range of the available band defined by the overall band value.

13. A packet-transmitting method as defined in claim 10, wherein the incoming packets are discarded when the determination result for each of the flows is shown falling out of the range of the available band defined by the upper limit band, and when the determination result for all of the flows is shown falling out of the range of the available band defined by the overall band value.

14. A packet-transmitting method as defined in claim 9, wherein the incoming packets are classified in accordance with header information of each of the incoming packets.

15. A packet-transmitting method as defined in claim 9, wherein the upper limit band is common to all of the flows.

16. A packet-transmitting method as defined in claim 9, wherein the upper limit band is weighted for each of the flows.

17. A packet-transmitting method comprsing:
receiving incoming packets and feeding non-discarded incoming packets sequentially to outside;
classifying the incoming packets for each flow; and
controlling each flow band using a token bucket,
wherein the token bucket has a rate varied in accordance with a band available for all of the flows.
